(19) United States
(12) Patent Application Publication
(10) Pub. No.: US 2008/0159292 A1
(43) Pub. Date: Jul. 3, 2008

(54) Method of routing data packets in a communication system

(76) Inventors: William Jiang, ShanDong (CN); Ricky Li, ShanDong (CN); Gene Liu, ShanDong (CN); Tony Ouyang, ShanDong (CN); Richard Sun, ShanDong (CN)

Correspondence Address: HARNESS, DICKEY & PIERCE, P.L.C., P.O. BOX 8910, RESTON, VA, 20195, US

(21) Appl. No.: 11/797,002

(22) Filed: Apr. 30, 2007

(30) Foreign Application Priority Data
Dec. 29, 2006 (CN) 200610172478.8

(51) Int. Cl. H04L 12/56; H04J 3/16

(52) U.S. Cl. 370/392; 370/466

(57) ABSTRACT

A method of routing a data packet in a communication system includes receiving a data packet at a first communication party operating in accordance with a first protocol. The method also includes adding a header to the data packet to produce modified data packet, the header including an identifier identifying the first protocol, first protocol information, an identifier identifying a second protocol, and second protocol information, and then sending the modified data packet to a second communication party operating in accordance with the second protocol through a first connection.

### PRIORITY STATEMENT

This non-provisional U.S. patent application claims priority under 35 U.S.C. § 119 to Chinese Patent Application No. 200610172478.8, filed on Dec. 29, 2006, the entire contents of which are incorporated herein by reference.

### BACKGROUND OF THE INVENTION

A personal handyphone system (PHS) is a type of hybrid telecommunication system. The PHS may be considered a digital cordless phone having wireless phone capabilities.

Compared to a typical wireless telecommunication system, the PHS is characterized by low mobility and low power. A user cannot be moving too quickly and must be within a limited range. Unlike, a true wireless telecommunication system, the PHS is an extension of a fixed network. A PHS base station (cell site) is connected to a network through a circuit switched telephone network system, for example, a public switched telephone network (PSTN), integrated service digital network (ISDN), etc. Operating a PHS is cheaper than a wireless telecommunication system because it can utilize existing fixed telephone systems and requires fewer infrastructure.

Similar to a typical wireless telecommunication system, a PHS is capable of delivering and providing data packet and multi-media services.

FIG. 1 illustrates a conventional PHS connected to a data packet server. A mobile station 10 is connected with a cell site (CS) 20. The CS 20 interfaces with a mobile switching center (MSC) 30 using an ISDN basic rate access (BRA) interface 25. The packet-switched network created between the CS 20 and the MSC 30 may be used to send X.25 data packet. X.25 is a well-known ITU Telecommunication Standardization Sector (ITU-T) standard protocol suite for wide area networks using a phone or ISDN system as the networking hardware. The X.25 standard defines standard physical layer, data link layer and network layers (layers 1 through 3) of the Open Systems Interconnection Reference Model (OSI model). The MSC 30 may pass/receive data packet to/from a data packet server 40 via an ISDN primary rate access (PRA) interface 35. The data packet server 40 may send/receive the data packet to an internet/intranet server 50.

FIG. 1 also illustrates a protocol stack layout for each of the CS 20, MSC 30, data packet server 40, and internet/intranet server 50. Functional details of each of the protocol stack layout are well-known to a person of ordinary skill, therefore for brevity, description thereof will be omitted.

The ISDN PRA interface 35 between the MSC 30 and data packet server 40 is a circuit interface. The MSC 30 provides an ISDN connection between the CS 20 and the data packet server 40. Each B channel of the CS 20 connects with one B channel of the ISDN PRA interface 35. In general, “B channel” means bearer channel, which refers to the ISDN channel that carries the primary data or voice communication. Therefore, to increase data packet call traffic, additional ISDN PRA interfaces are required.

### SUMMARY OF THE INVENTION

In an example embodiment, a method of routing data packets in a communication system includes receiving a data packet at a first communication party operating in accordance with a first protocol. A header is added to the data packet to produce a modified data packet. The header includes an identifier identifying the first protocol, first protocol information, an identifier identifying a second protocol, and second protocol information. The method further includes sending the modified data packet to a second communication party operating in accordance with the second protocol through a first connection.

In another example embodiment, a method of routing data packets in a communication system includes receiving data packet from a first communication party at a second communication party through a connection. The first communication party operates accordance with a first protocol and the second communication party operates in accordance with a second protocol. The data packet includes a header, and the header includes an identifier identifying the first protocol, first protocol information, an identifier identifying the second protocol, and second protocol information. The method further includes removing the header at the second communication party.

### BRIEF DESCRIPTION OF THE DRAWINGS

Example embodiments of the present invention will become more fully understood from the detailed description given herein below and the accompanying drawings, which are given by way of illustration only and thus are not limiting of the example embodiments of the present invention.

FIG. 1 illustrates a conventional personal handyphone system (PHS) and protocol stack structures of the conventional PHS.

FIG. 2 illustrates an example embodiment of a personal handyphone system (PHS) of the present invention and protocol stack structures of the example embodiment of the present invention.

FIG. 3 illustrates an example embodiment of a PHS packet over TCP/IP (PPOT) header of the present invention.

FIG. 4 is flow chart illustrating a setup procedure of an example embodiment of the present invention.

FIG. 5 is flow chart illustrating a disconnect procedure of an example embodiment of the present invention.

FIG. 6 is another example embodiment of the protocol stack structures of the present invention.

FIG. 7 is still another example embodiment of the protocol stack structures of the present invention.

FIG. 8 is yet another example embodiment of the protocol stack structures of the present invention.

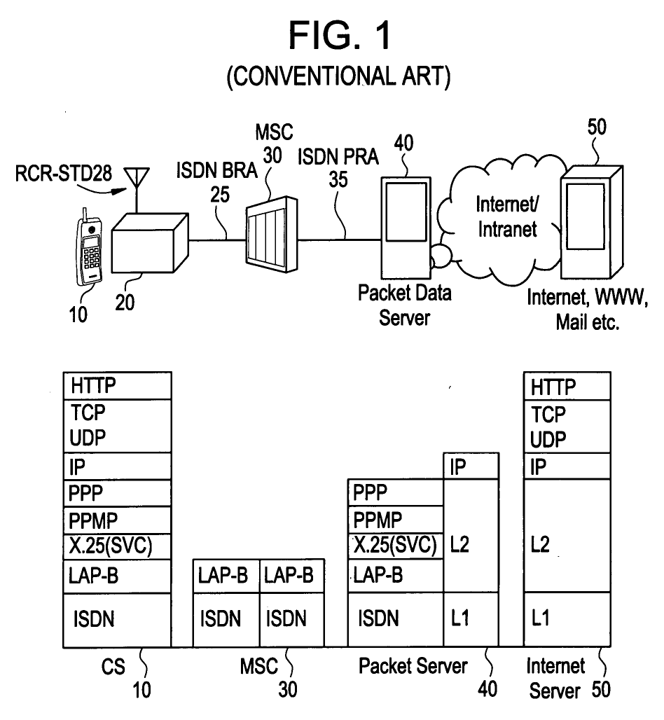

### DETAILED DESCRIPTION OF EXAMPLE EMBODIMENTS

Although example embodiments of the present invention will be described with reference to a personal handyphone system (PHS), a person of ordinary skill will recognize the present invention may apply to other telecommunication systems.

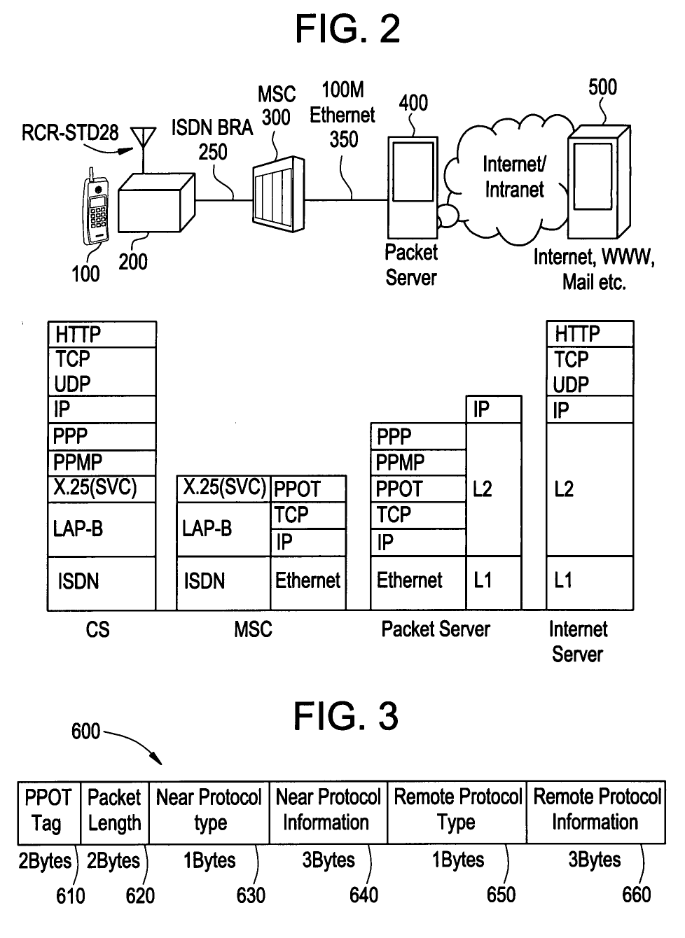

In an example embodiment of a personal handyphone system (PHS) of the present invention as illustrated in FIG. 2, a mobile station 100 is connected with a cell site (CS) 200. The CS 200 interfaces with a mobile switching center (MSC) 300 using an ISDN basic rate access (BRA) interface 250. The packet-switched network created between the CS 200 and the MSC 300 may be used to send X.25 data packets. The MSC 300 may pass/receive data packet to/from a data packet server 400 via an Ethernet 350. The Ethernet 350 may be a 10 Megabit per second (Mbps) system, 100 Mbps Fast Ethernet (802.3u), 1000 Mbps Gigabit Ethernet (802.3z/802.3ab), a 10 Gigabit Ethernet (802.3ae), etc. The data packet server 400 may send/receive the data packet to/from an internet/intranet server 500. The MSC 300 is responsible for setting-up a circuit ISDN (BRA) connection with the CS 200, and passing data packet on top of the circuit ISDN (BRA) connection to the data packet server 400 via the Ethernet 350, for example, a transmission control protocol/internet protocol (TCP/IP) connection.

As further illustrated in the protocol stack structure of FIG. 2, an X.25 switched virtual circuit (SVC) connection is set-up between the CS 200 and MSC 300. The MSC 300 adds a personal handyphone system (PHS) Packet over TCP/IP (PPOT) header to any PHS packet management protocol (PPMP) data packets received through the X.25 SVC, and transfers the data packets to the data packet server 400 through the Ethernet 350.

The PPOT protocol informs the two communication parties connected by the TCP/IP connection of the local protocols, e.g., the X.25 protocol at the MSC 300 and the PPMP protocol at the packet server 400, run by each communication party. The information is passed over the PPOT headers. Here, the two communication parties are the MSC 300 and the data packet server 400. The MSC 300 communicates to the CS 200 through the X.25 SVC connection over the ISDN (BRA) interface 250, and communicates to the packet server 400 through the PPMP over the TCP/IP connection (Ethernet 350).

Each of the X.25 session and the PPMP session is uniquely mapped with each other. The PPOT header carries the X.25 and PPMP information over the Ethernet connection. Accordingly, whenever the X.25/PPMP packet is received by the remote party, the remote party may take appropriate action on its local protocol stack such as establishing the X.25/PPMP session, disconnecting the X.25/PPMP session, etc.

The PPOT exchanges information between the X.25 layer and PPMP layer by associating the X.25 SVC connection and TCP/IP connection to a single data path for a data packet call. The MSC 300 has the capacity to maintain the single data path. The MSC 300 adds the PPOT header to all packets transmitted from CS 200. The MSC 300 further transmits the packets to the packet server 400. The MSC 300 also removes the PPOT header from all packets received from the packet server 400, and transmits the packets to the CS 200. The PPMP layer terminates at the data packet server 400 and the X.25 SVC terminates at the MSC 200. The PPOT layer provides the communication link between the two layers.

The PPOT layer may contain a near side and a remote side protocol, and protocol specified information. In the present example embodiment, the near side protocol is X.25 SVC, and the remote side protocol is PPMP.

FIG. 3 illustrates an example embodiment of a PPOT protocol header 600. The PPOT protocol header 600 may include the following fields: a PPOT tag 610, a packet length 620, a near protocol type 630, near protocol information 640, a remote protocol type 650, and remote protocol information 660.

The PPOT tag 610 is hard coded, for example, as 0xffff. The PPOT tag 610 may be added by both the MSC 200 and the data packet server 400 to identify the PPOT header 600. The packet length 620 defines the total length of the packet. The near protocol type 630 is an identifier identifying the near side protocol type, for example, X.25 (SVC) when the packet is sent by the MSC 300. The terms “near” and “remote” may be designated based on who sent the packet. The near protocol information 640 contains any near side protocol specified information, or any information requested by the remote protocol. The remote protocol type 650 is an identifier identifying the remote side protocol, for example, PPMP when the packet is sent by the MSC 300. The remote protocol information 660 contains any remote side protocol specified information, or any information requested by the near side protocol.

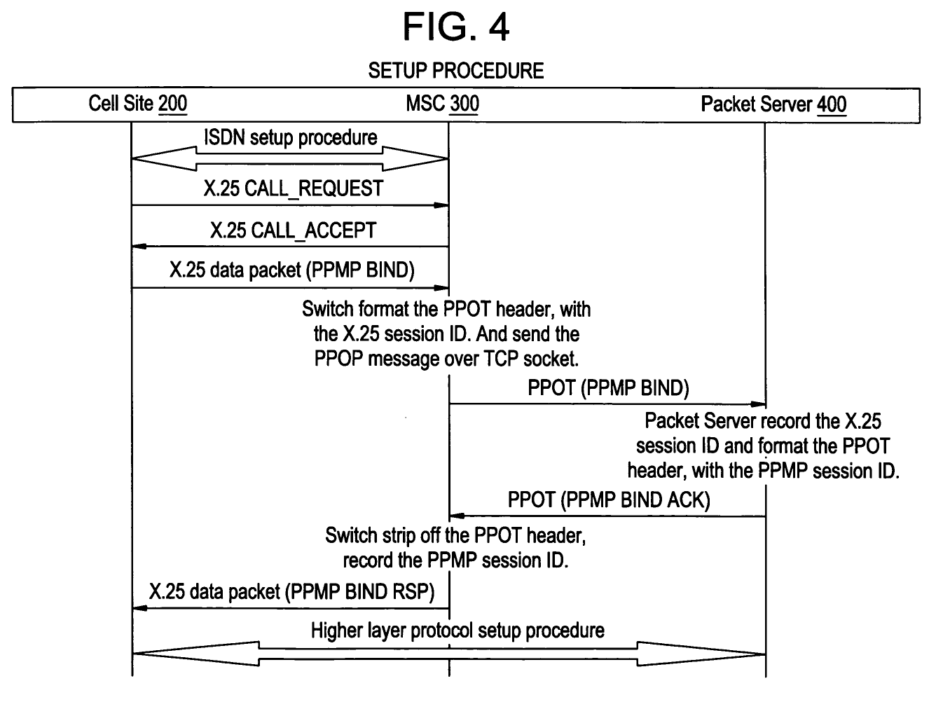

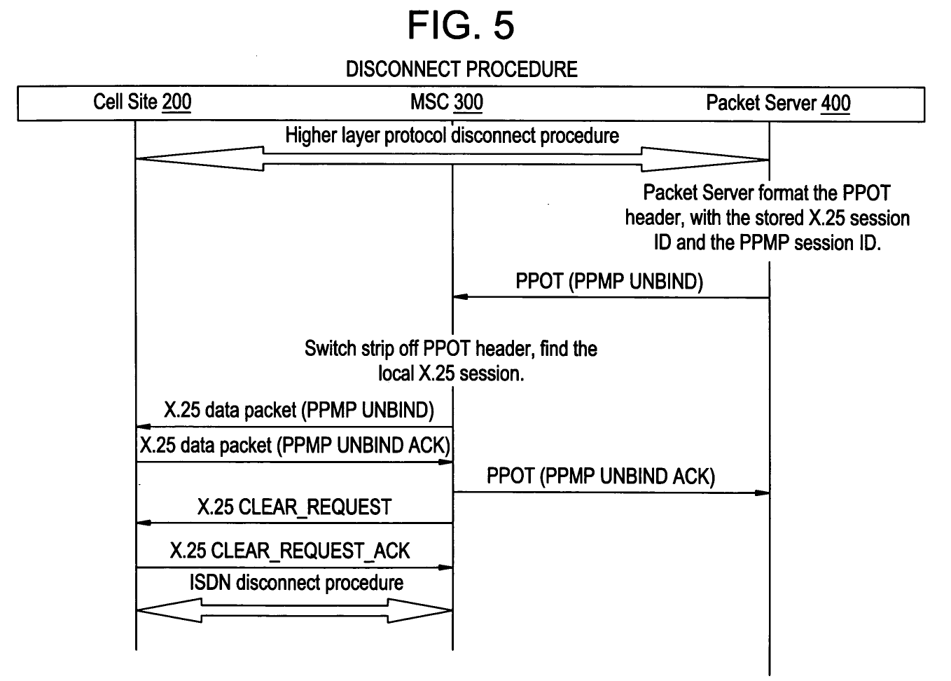

Next, operation of this example embodiment will be described in greater detail with respect to FIGS. 4 and 5.

FIG. 4 is flow chart illustrating a setup procedure of an example embodiment of the present invention.

Initially, a cell site (CS) 200 and a mobile switching center (MSC) 300 establish an ISDN setup in the conventional manner. Next, the CS 200 transmits an X.25 CALL_REQUEST to the MSC 300. In reply, the MSC 300 transmits an X.25 CALL_ACCEPT to the CS 200. Then, the CS 200 transmits an X.25 data packet (PPMP BIND) to the MSC 300. The MSC 300 formats a PPOT header with an X.25 session ID in a near protocol info field, and sends the PPOT (PPMP BIND) over a TCP socket of the Ethernet 350 to a data packet server 400.

The data packet server 400 records the X.25 session ID on the PPMP BIND message, sets-up the PPMP session, and associates the PPMP session to the X.25 SVC session ID. Then, the data packet server 400 formats the PPOT header with the PPMP session ID in the near protocol info field, and the X.25 SVC session ID in the remote protocol info field. The data packet server 400 also transmits a PPOT acknowledgement (PPMP BIND ACK) to the MSC 300. The MSC 300 strips off the PPOT header and records the PPMP session ID. The MSC 300 also transmits the X.25 data packet response (PPMP BIND RSP) to the CS 200.

It will be appreciated that the same procedure, in reverse, may take place to set-up a connection initiated by the data packet server 400; albeit, the data packet server 400 becomes the near side and the MSC 300 becomes the remote side.

FIG. 5 is flow chart illustrating a disconnect procedure of an example embodiment of the present invention.

Initially, after a packet server 400 formats a PPOT header with a stored X.25 session ID and a PPMP session ID, the packet server 400 transmits a PPOT (PPMP UNBIND) to a MSC 300. The MSC 300 strips off the PPOT header and finds the local X.25 session. The MSC 300 transmits an X.25 data packet (PPMP UNBIND). In response, CS 200 transmits an X.25 data packet (PPMP UNBIND ACK). The MSC 300 further transmits a PPOT (PPMP UNBIND ACK) to the data packet server 400.

The MSC 300 sends an X.25 CLEAR_REQUEST, and the CS 200 returns an X.25 CLEAR_REQUEST_ACK. Finally, the CS 200 and the MSC 300 disconnects the ISDN connection in the conventional manner. It will be appreciated that the same procedure may be applied in reverse.

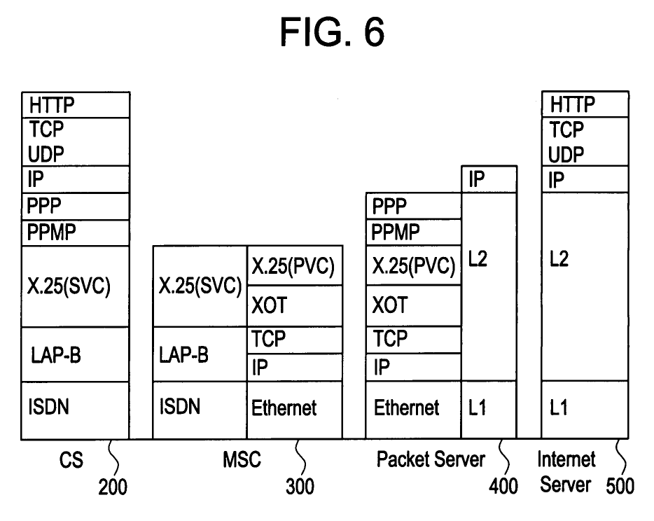

FIG. 6 illustrates another example embodiment of the stack protocol structures of the present invention. In this example embodiment, the PPOT layer is replaced by the X.25 permanent virtual circuit (PVC) layer and X.25 over TCP/IP (XOT) layer. The SVC is mapped to the PVC, and the PVC/XOT header exchanges information between the MSC 300 and the packet server 400.

An X.25 (PVC) connection is established between the MSC 300 and the data packet server 400. The MSC 300 maintains the inter-connection between the X.25 (SVC) connection and the X.25 (PVC) connection. The XOT layer informs the MSC 300 and the data packet server 400 that the XOT connection is X.25 (PVC).

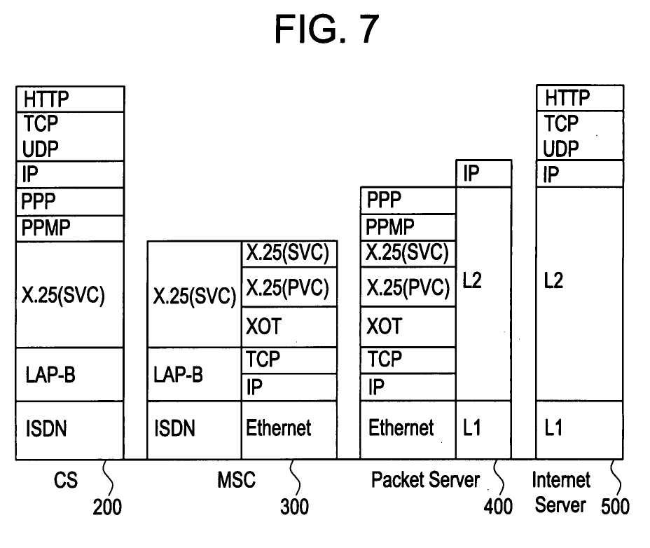

FIG. 7 illustrates another example embodiment of the stack protocol structures according to the present invention. In this example embodiment, a SVC connection is established between the CS 200 and the data packet server 400. The X.25 (PVC) and the XOT layers are added between the X.25 (SVC) layer and the TCP layer.

In general, it is easier to maintain a PVC connection than a SVC connection. Therefore, in the example embodiment of the present invention, the MSC 300 can only maintain an ISDN circuit connection with the CS 200, and a PVC connection to the data packet server 400, the X.25 (SVC) connection (between the CS 200 and the data packet server 400) is on top of the ISDN circuit and the PVC connections, and transparent to the MSC 300. The MSC 300 adds the X.25 (PVC) and the XOT headers to any packets received from the ISDN connection (e.g., LAPB), and sends the packets to the data packet server 400. The MSC 300 also removes the X.25 (PVC) and the XOT header for any packets received from the data packet server 400 and sends the packets to the CS 200.

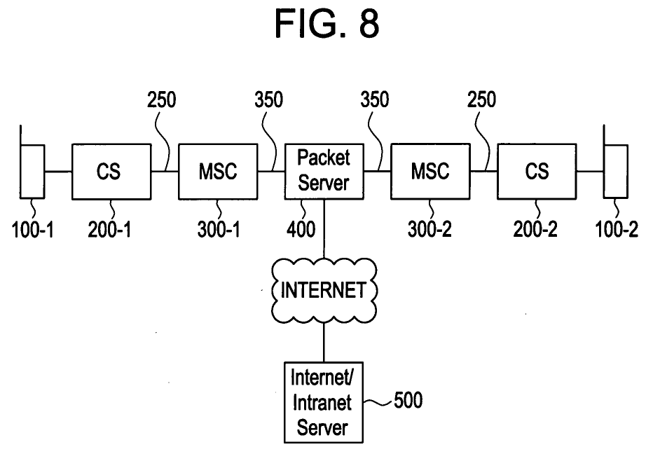

FIG. 8 illustrates an example embodiment where one mobile station 100-2 sends a data packet to another mobile station 100-1. A person of ordinary skill will appreciate that all the methods of routing a data packet as disclosed above with respect to FIGS. 2-7 apply to this example, therefore, detail explanation thereof will be omitted.

A mobile station 100-2 sends a data packet to a mobile station 100-1 by first connecting with a CS 200-2. The CS 200-2 interfaces with a MSC 300-2 using an ISDN basic rate access (BRA) interface 250. The packet-switched network created between the CS 200-2 and the MSC 300-2 is used to send X.25 data packet.

The MSC 300-2 establishes a connection (e.g., Ethernet) 350 with a data packet server 400 according to one of the methods disclosed above; and the data packet server 400 also establishes a separate connection (e.g., Ethernet) 350 with MSC 300-1 according to one of the methods disclosed above. The data packet server 400 also interconnects the separate connections so that the mobile station 100-2 may communicate (pass data packets) with the mobile station 100-1. In other words, the protocol layers established between data packet server 400 and the MSC 300-2 and between data packet server 400 and the MSC 300-1 are the same.

FIG. 8 illustrates an example where the data packet server 400 may be the remote side with respect to the MSC 300-2 and the near side with respect to the MSC 300-1.

It will also be appreciated that data packet may be sent from the internet/intranet server 500 to, either or both of the mobile stations 100-1, 100-2. The connection procedures, establishing the protocol layers, etc. are the same in this example as disclosed above.

Accordingly to example embodiments of the present invention, an X.25 protocol is parsed only at a mobile switching center (MSC) and transparent to a packet server, and a PPMP protocol is only parsed at the packet server and transparent to the MSC. Using a PPOT to exchange each other's information, an X.25 connection and a PPMP connection may be associated. Therefore, whenever a X.25 message (data packet) is transmitted from a cell site (CS) to the MSC, the MSC recognizes which PPMP session it belongs to, and whenever a PPMP packet is received from the packet server, the MSC recognize which X.25 session it belongs to. Accordingly, the MSC may easily control packet transmissions, call setups, and disconnect procedures.

In addition, if the MSC and the packet server are provided by different vendors, the MSC vendors do not have to develop a PPMP protocol and the packet server vendors do not have develop an X.25 protocol—both of the vendors just have to follow the PPOT protocol.

The example embodiments of the present invention being thus described, it will be obvious that the same may be varied in many ways. For example, while an example implementation of the present invention has been described with respect to a personal handyphone system (PHS), it will be appreciated that the present invention is applicable to other telecommunication systems. Such variations are not to be regarded as a departure from the invention, and all such modifications are intended to be included within the scope of the invention.

What is claimed is:

1. A method of routing data packets in a communication system, comprising:
receiving a data packet at a first communication party operating in accordance with a first protocol;
adding a header to the data packet to produce a modified data packet, the header including an identifier identifying the first protocol, first protocol information, an identifier identifying a second protocol, and second protocol information; and
sending the modified data packet to a second communication party through a first connection operating in accordance with the second communication.

2. The method of claim 1, wherein the first protocol is an X.25 protocol and the second protocol is a personal handyphone system (PHS) packet management protocol (PPMP).

3. The method of claim 2, wherein the first connection is a transmission control protocol/internet protocol (TCP/IP) connection.

4. The method of claim 3, wherein the first connection is made over an Ethernet.

5. The method of claim 1, wherein the first protocol is an X.25 protocol and the second protocol is a TCP/IP (XOT) protocol.

6. The method of claim 5, wherein the first connection is an X.25 permanent virtual circuit (PVC) connection.

7. The method of claim 6, wherein the first connection is made over an Ethernet.

8. The method of claim 1, wherein the added header further includes a tag identifying the header and packet length information for the modified data packet.

9. The method of claim 1, wherein the second protocol is an X.25 protocol and the first protocol is a personal handyphone system (PHS) packet management protocol (PPMP).

10. The method of claim 9, wherein the first connection is a transmission control protocol/internet protocol (TCP/IP) connection.

11. The method of claim 10, wherein the first connection is made over an Ethernet.

12. The method of claim 1, wherein the second protocol is an X.25 protocol and the first protocol is a TCP/IP (XOT) protocol.

13. The method of claim 12, wherein the first connection is an X.25 permanent virtual circuit (PVC) connection.

14. The method of claim 13, wherein the first connection is made over an Ethernet.

15. The method of claim 1, wherein the receiving step receives the data packet over a second connection.

16. The method of claim 15, wherein the second connection is an X.25 switched virtual circuit (SVC).

17. The method of claim 16, wherein the second connection is made over an integrated service digital network (ISDN).

18. A method of routing data packets in a communication system, comprising:
receiving data packet from a first communication party at a second communication party through a connection, the first communication party operating in accordance with a first protocol and the second communication party operating in accordance with a second protocol, the data packet including a header, the header including an identifier identifying the first protocol, first protocol information, an identifier identifying the second protocol, and second protocol information; and
removing the header at the second communication party.

19. The method of claim 18, wherein the first protocol is an X.25 protocol and the second protocol is a personal handyphone system (PHS) packet management protocol (PPMP).

20. The method of claim 18, wherein the first protocol is an X.25 protocol and the second protocol is a TCP/IP (XOT) protocol.

21. The method of claim 18, wherein the second protocol is an X.25 protocol and the first protocol is a personal handyphone system (PHS) packet management protocol (PPMP).

22. The method of claim 18, wherein the second protocol is an X.25 protocol and the first protocol is a TCP/IP (XOT) protocol.

23. The method of claim 22, wherein the connection is made over an Ethernet.
